(19) United States
(12) Patent Application Publication
(10) Pub. No.: US 2001/0026029 A1
(43) Pub. Date: Oct. 4, 2001

(54) Method for producing and applying a screening profile

(76) Inventors: Gerhard Schaal, Sigmaringendorf (DE); Klaus-Dieter Korn-Amann, Sigmaringen (DE)

Correspondence Address: FACTOR & PARTNERS, LLC, 1327 W. WASHINGTON BLVD., SUITE 5G/H, CHICAGO, IL, 60607, US

(21) Appl. No.: 09/739,579

(22) Filed: Dec. 18, 2000

(30) Foreign Application Priority Data
Dec. 18, 1999 (DE) 199 61 187.4

(51) Int. Cl. B29C 39/10; B29C 43/18

(52) U.S. Cl. 264/259

(57) ABSTRACT

The procedure for producing a screening profile of a resilient and electrically conductive sealing material for a housing (5), which is intended to receive electrical function elements, is as follows: In a first step of the method, the sealing material (4) is introduced into the groove-shaped mold cavity (2) of a negative mold (1). The course and the cross-section of the mold cavity (2) correspond to the course and the cross-section of the screening profile to be produced. The sealing material (4) initially protrudes somewhat above the mold cavity (2). If, in a second step of the method, the housing (5) to be provided with the screening profile is now placed in an appropriate position on the negative mold (1), those faces of the housing (5) which are to be provided with the screening profile contact the protruding region of the sealing material (4), pressing it back into the mold cavity (2) accordingly. In the third step of the method, the housing (5) is fixed in this position on the negative mold (1) until the sealing material (4) has hardened sufficiently. The housing (5) having the adherent screening profile (4) can then be removed from the negative mold (1).

The invention relates to a method for producing and applying a screening profile of a resilient and electrically conductive sealing material, in which this latter is applied in a paste-like condition to a portion of a housing part for electrical function elements, in particular a housing portion of a radio telephone, and hardens there.

A method of this type is disclosed in DE-U-94 04 291. Here, the sealing material is applied directly to those faces of the housing which are to be provided with the screening profile. This takes place with the aid of a dispensing needle which, guided by a robotic arm, is guided along the contour of the screening profile to be produced. The cross-sectional shape of the resulting screening profile adapts itself substantially according to the viscosity and the wetting properties of the sealing material in conjunction with the quantity applied per unit time and the feed rate of the dispensing needle. If the screening profile is to have a cross-section which does not adapt “automatically”, the dispensing needle has to be guided a plurality of times along the same path, discharging a track each time.

In many cases, however, it is important for the screening profile to have a defined cross-sectional face: the sealing material needs to be compressed to a certain extent to achieve the required conductivity. The shape of the cross-sectional face of the screening profile should be such that the forces required for this compression of the sealing material are not too great.

The object of the present invention is to provide a method of the type mentioned at the outset, such that defined cross-sections of the screening profile can be achieved using simple means.

This object is achieved in that,

a) in a first step of the method, the sealing material is introduced into a groove-shaped mold cavity of a negative mold, the course and cross-section of which correspond to the course and cross-section of the screening profile to be applied to the housing, regions of the sealing material which is introduced projecting above the mold cavity;

b) in a second step of the method, those faces of the housing which are to be provided with the screening profile are placed on the sealing material located in the mold cavity, such that the protruding region of the sealing material in contact with these faces is pressed back into the mold cavity;

c) the housing is fixed in position on the negative mold until the sealing material has hardened sufficiently;

d) the housing having an adherent screening profile is removed from the negative mold.

By using the negative mold in the manner according to the invention, it is possible to produce any desired cross-section of the screening profile in extremely precise manner (provided only that it can be released from the mold). In particular, it is possible to achieve cross-sections of screening profiles which can be compressed using very little force to the extent necessary for obtaining the desired conductivity. However, as in the method mentioned at the outset, which is disclosed in DE-U-94 04 291, the screening profile does not have to be placed on the housing as a loose part or fixed thereto, for example by adhesion, in a separate process step, but is instead formed by hardening directly “in situ” on the housing. In terms of the production technique, the method according to the invention is therefore virtually as favourable as the said known method.

The hardening of the sealing material is expediently accelerated by heating. For this, it is in turn recommended that the negative mold be heated. This can take place for example in that, passing through the negative mold, there are heating channels through which there flows a heating medium, for example hot water or vapour, which has been brought to the appropriate temperature.

The mold cavity of the negative mold is advantageously filled with sealing material with the aid of a dispensing needle, which is guided along the course of the mold cavity. This enables the sealing material to be dispensed particularly well, so that it fills the mold cavity in the desired manner.

Alternatively, however, it is also possible to fill the mold cavity of the negative mold with sealing material with the aid of a doctor blade.

An exemplary embodiment of the invention is explained in more detail below with reference to the drawing, in which:

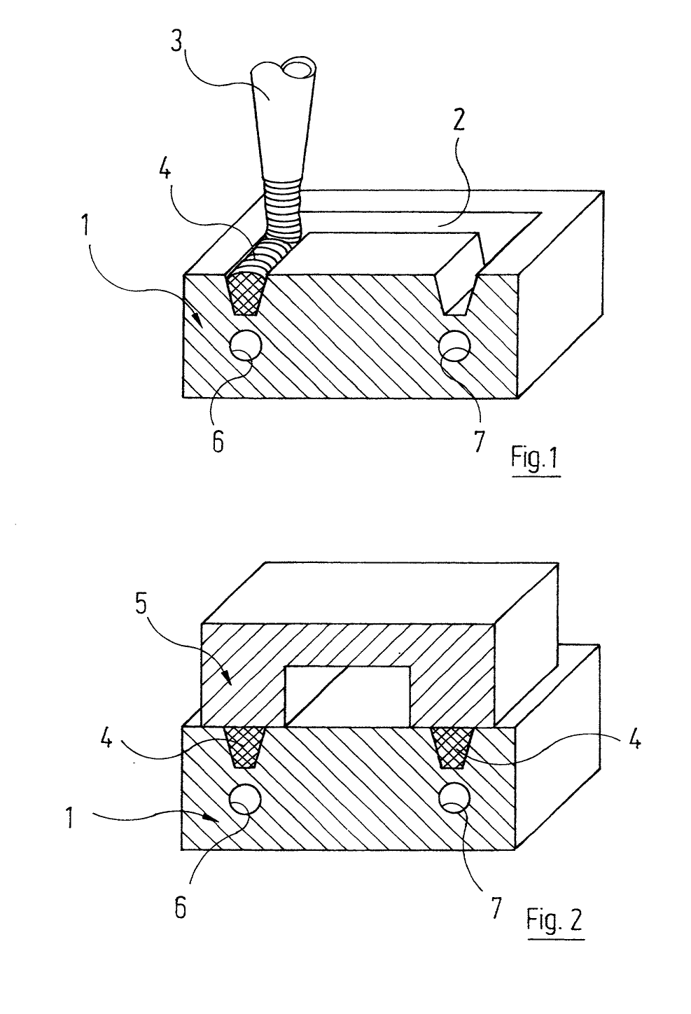

FIG. 1 shows schematically how, in a first step of the method, the resilient and conductive sealing material is introduced into the mold cavity of a negative mold;

FIG. 2 shows how, in a second step of the method, the housing to be provided with the screening profile is placed onto the negative mold; and

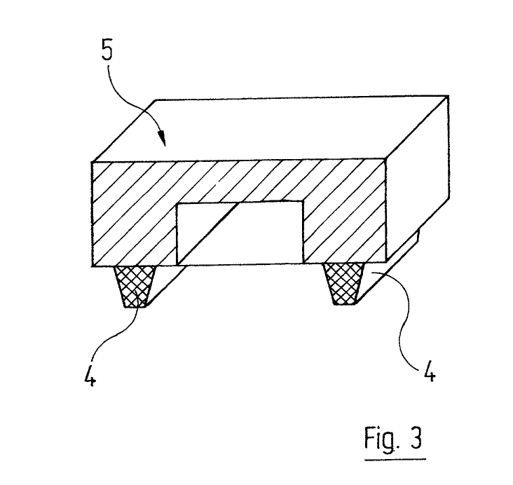

FIG. 3 shows the completed housing provided with the screening profile.

Reference is made first of all to FIG. 1. This shows, in section, a negative mold 1, in the upper end face of which a groove-shaped mold cavity 2 is incorporated. The mold cavity 2 extends along a contour which corresponds to the course of the wall of the housing to be provided with the screening profile. The cross-sectional shape of the mold cavity 2 corresponds in complementary manner to the profile of the screening profile to be produced.

In the first step of the method illustrated in FIG. 1, a dispensing needle 3 is used to fill the mold cavity 2 with a quantity of sealing material 4 which is such that the sealing material 4 which is introduced fills the groove-shaped mold cavity 2 completely after it has been smoothed. Owing to the surface tension, as the sealing material 4 is introduced, however, a track is first of all produced which has a convex surface as seen from above. In the center of the mold cavity 2, this convex surface projects above the corresponding end face of the negative mold 1, whilst remaining below this end face at the edges.

When the entire groove-shaped mold cavity 2 is filled with sealing material 4 in the manner illustrated in FIG. 1, the housing 5 to be provided with the screening profile is pressed downwards onto the track located in the mold cavity 2 by means of the end faces of the walls intended to support the screening, such that the hitherto still convex, upwardly pointing side of this track is pressed flat and is now in contact with the wall of the housing 5, filling the entire profile cross-section of the mold cavity 2. It goes without saying that at this point the sealing material 4 has not yet hardened.

The housing 5 is fixed in this position (illustrated in FIG. 2) on the negative mold 1 and remains there until the sealing material 4 has hardened sufficiently, adhering to the end face of the housing walls. The time required for this can be reduced by heating the entire arrangement. In the case of the exemplary embodiment illustrated in the drawing, for this purpose the negative mold 1 has heating channels 6, 7 through which a heating fluid which has been brought to a suitable temperature is guided. This can be for example hot water or vapour.

After the sealing material 4 has hardened, the housing 5 can be lifted away from the negative mold 1. The sealing material which has now become the screening profile 4, is thereby released from the negative mold 1, and this can be assisted by an appropriate lining (not illustrated in the drawing) of the mold cavity 2. Oblique mold-release faces on the screening profile 4 also facilitate removal of the housing 5.

This produces the housing 5 illustrated in FIG. 3, which is provided at the end faces of its walls with a screening profile 4 having the precise cross-section desired.

The negative mold 1, which is used in the method described, can be made of a metal material. However, it is also possible to use a shaped-out film or a plastics body for this.

1. A method for producing and applying a screening profile of a resilient and electrically conductive sealing material, in which this latter is applied in a paste-like condition to a portion of a housing part for electrical function elements, in particular to a housing portion of a radio telephone, and hardens there, characterised in that
a) in a first step of the method the sealing material (4) is introduced into a groove-shaped mold cavity (2) of a negative mold (1), the course and cross-section of which corresponds to the course and the cross-section of the screening profile to be applied to the housing (5), regions of the sealing material (4) which is introduced projecting somewhat above the mold cavity (2);
b) in a second step of the method those faces of the housing (5) which are to be provided with the screening profile are placed on the sealing material (4) located in the mold cavity (2), such that the protruding region of the sealing material (4) in contact with these faces is pressed back into the mold cavity (2);
c) the housing (5) is fixed in position on the negative mold (1) until the sealing material (4) has hardened sufficiently;
d) the housing (5) having an adherent screening seal (4) is removed from the negative mold (1).

2. A method according to claim 1, characterised in that the hardening of the sealing material (4) is accelerated by heating.

3. A method according to claim 2, characterised in that the negative mold (1) is heated.

4. A method according to one of the preceding claims, characterised in that the mold cavity (2) of the negative mold (1) is filled with sealing material (4) with the aid of a dispensing needle (3), which is guided along the course of the mold cavity (2).

5. A method according to one of claims 1 to 3, characterised in that the mold cavity (2) of the negative mold (1) is filled with sealing material with the aid of a doctor blade.
